(19) United States
(12) Patent Application Publication
(10) Pub. No.: US 2006/0022520 A1
(43) Pub. Date: Feb. 2, 2006

(54) Exterior indicator of the activation of an anti-lock braking system

(76) Inventor: David Matheny, The Woodlands, TX (US)

Correspondence Address: Darcell Walker, Attorney, Suite 250, 9301 Southwest Freeway, Houston, TX, 77074, US

(21) Appl. No.: 11/192,545

(22) Filed: Jul. 30, 2005

Related U.S. Application Data
(60) Provisional application No. 60/522,010, filed on Aug. 2, 2004.

(51) Int. Cl. B60T 8/66

(52) U.S. Cl. 303/167

(57) ABSTRACT

An exterior ABS alerting system takes the existing signal from the ABS ‘Electronic Brake Control Module’ that currently displays to the vehicle driver the activation of the ABS and sends that signal to an ‘exterior ABS alerting system. Once the exterior ABS alerting system receives this signal, the conventional rear brake lights can be strobed or could rapidly flash to alert oncoming and following vehicles of a braking duress by a vehicle. The braking indicator could simultaneously or sequentially strobe or fast flash to alert other drivers of emergency braking conditions. The exterior alerting module would only act in an over-ride capacity. Once the signal from the EBCM ceases, the exterior alert module ceases to override normal brake lamp operations.

### CROSS-REFERENCE TO RELATED APPLICATIONS

This application is related to and claims priority from provisional patent application number 60/522,010 filed on Aug. 2, 2004, the contents of which are incorporated herein by reference.

### FIELD OF THE INVENTION

This invention refers to system that alerts drivers of the activation of an anti-lock braking system of an automobile in close proximity and in particular to a system within a motor vehicle that detects the activation of the anti-lock braking system of that vehicle and displays a signal on the vehicle's external surface that alerts other drivers in close proximity of the vehicle of the activation of the anti-lock braking system of that vehicle.

### BACKGROUND OF THE INVENTION

The theory behind anti-lock brakes is simple. A skidding wheel (where the tire contact patch is sliding relative to the road) has less traction than a non-skidding wheel. If the driver has been stuck on ice, they know that when wheels are spinning there is no traction. When tires are just spinning, the contact patch is sliding relative to the ice. By keeping the wheels from skidding while a driver slows down, anti-lock brakes benefit drivers in two ways: 1) the driver will stop faster and 2) the driver will be able to steer while bring the car to a stop.

Many authorities, especially in the automotive industry believe Anti-lock Braking Systems (ABS) are the most significant safety development since the seatbelt. Basically, there are sensors at each of the four wheels (or in the case of the less sophisticated three-channel system, one on each of the fronts and only one for the pair of rears). These sensors watch the rotation of the wheels. When any one of the wheels stops rotating due to too much brake application, the sensors tell the car's computer, which then releases some of the brake line pressure that the driver has applied, allowing the wheel to turn again. Then, just as fast as it released the pressure, the computer allows the pressure to be applied again—which stops the rotation of the wheel again. Then it releases it again. And so on. With most ABS, this releasing and re-application—or pulsing—of the brake pressure happens 20 or more times per second. Practically speaking, this keeps the wheel just at the limit—the threshold—before locking up and skidding. ABS prevents the driver from ever locking up the brakes and skidding—no matter how hard you apply the brakes. Obviously, this is going to mean much more steering control.

An ABS has four main components: speed sensors, pumps, valves and controller. The anti-lock braking system needs some way of knowing when a wheel is about to lock up. The speed sensors, which are located at each wheel, or in some cases in the differential, provide this information. There is a valve in the brake line of each brake controlled by the ABS. On some systems, the valve has three positions. In position one, the valve is open; pressure from the master cylinder is passed right through to the brake. In position two, the valve blocks the line, isolating that brake from the master cylinder. This prevents the pressure from rising further should the driver push the brake pedal harder. In position three, the valve releases some of the pressure from the brake. Since the valve is able to release pressure from the brakes, there has to be some way to put that pressure back. That is what the pump does; when a valve reduces the pressure in a line, the pump is there to get the pressure back up. The controller is a computer in the car. It watches the speed sensors and controls the valves.

When the driver activates vehicle brakes external lights illuminate to alert other drivers that the car has activated the vehicle brakes, which indicate that, the vehicle is reducing speed. With this system, drivers are able to adjust the speed of their vehicles in response to the reduction of the speed of the vehicle with the illuminated brake lights. Many systems exist for alerting drivers of the gradual or sudden braking actions of a vehicle.

U.S. Pat. No.: 6,445,289 describes an emergency braking alert system providing a strobing visual indication of rapid deceleration of a vehicle traveling above a pre-determined minimum speed includes a microcontroller operationally coupled to the braking system and the speedometer of a vehicle.

U.S. Pat. No.: 6,417,767 describes a device and system for indicating rapid deceleration to warn the operator and/or others of an urgent deceleration condition is provided. The device includes one or more sensors that are responsive to acceleration in the primary direction of vehicle motion.

U.S. Pat. No.: 6,351,211 describes a brake strobe system (BSS) providing a state of the art visual warning system designed to prevent accidents and multi-car pileups. When a driver quickly and forcefully applies his brakes, a strobe light (which is built into the third brake light or all brake lights) is activated. The harder a driver brakes, the faster and brighter the strobe blinks, thereby warning other drivers of potential hazards.

U.S. Pat. No.: 5,850,177 describes an anti-lock braking system indicator including a brake switch relay for transmitting power upon the depression of a brake pedal of the vehicle. Associated therewith is an anti-lock braking system relay for transmitting power only upon both the prevention of wheels of the vehicle from locking during braking and the transmission of power by the brake switch. At least one lamp is mounted on the vehicle. Finally, a strobe mechanism is connected between the relay and each of the lamps. The strobe mechanism is adapted to intermittently transmit power to each lamp upon the receipt thereof.

UK Patent Application GB 2 280 070 describes a vehicle brake light system comprising one or more supplementary brake lights, a source of electrical current, and a deceleration sensor configured to initiate the passage of current to illuminate the supplementary brake lights only upon detection of a rate of deceleration greater than a predetermined value. Such an arrangement gives the driver of a following vehicle visual warning of heavy or emergency braking which the driver would not receive from the standard the brake lights.

UK Patent Application GB 2 269 493 describes a device fitted to the braking system of a motor vehicle that is sensitive to pressure and time so as to monitor the degree of force/severity of braking and the speed of brake application. In emergency braking conditions the device causes one or more warning lights to flash on and off.

Although, there are braking systems that have many designs and configurations for alerting drivers of the activation of vehicles brakes of a vehicle, there still remains a need for an anti-lock braking system in uses the conventional and existing brake light system of the motor vehicle to indicate to other drivers the activation of the ABS of the vehicle.

### SUMMARY OF THE INVENTION

It is an objective of the present invention to provide an anti-lock braking system (ABS) that indicates to other drivers the activation of the ABS.

It is a second objective of the present invention to provide a system that indicates the activation of an ABS using the existing lights used to indicate conventional braking actions.

It is a third objective of the present invention to provide an illumination module, that can be incorporated into a conventional or existing braking system, that provides an external indication of the activation of the ABS of the motor vehicle.

It is a fourth objective of the present to provide an exterior ABS alerting system with a strobe module.

The ABS system provides crucial safety information to the driver of a vehicle about the braking status of the car during the activation of the ABS. The braking system of the vehicle detects an ‘in extremis’ situation. This information is useful not only to the driver of the vehicle but this information is also valuable to other drivers and in particular the drivers behind the ‘in extremis’ vehicle.

The present invention provides an exterior ABS alerting system (EABSAS) that takes the existing signal from the ABS ‘Electronic Brake Control Module’ (EBCM) that is currently displayed to the vehicle driver and send that signal to an ‘exterior alert module’. Once the exterior ABS alerting system (EABSAS) receives this signal, the conventional rear brake lights could be strobed or could fast flash to alert the oncoming/approaching and following vehicles of a braking duress by a vehicle. The braking indicator could simultaneously or sequentially strobe or fast flash to alert other drivers of emergency braking conditions. The exterior alerting module would only act in an over-ride capacity. Once the signal from the EBCM ceases, the exterior alert module ceases to override normal brake lamp operations. The system of the present invention could be programmed to utilize only the third brake light or all existing brake lamp operations. This system could also use the white reverse lights. The EABSAS module could activate emergency flashers if: (1) the vehicle comes to a halt (ABS signal ceases) and (2) a crash is detected via air bag sensor signal.

### DESCRIPTION OF THE DRAWINGS

FIG. 1 is an illustration of a basic concept for a motor vehicle brake system.

FIG. 2 is a schematic of a conventional brake lighting system.

FIG. 3 is a schematic of a braking lighting system for an anti-lock brake system in accordance with the present invention.

### DETAILED DESCRIPTION OF THE INVENTION

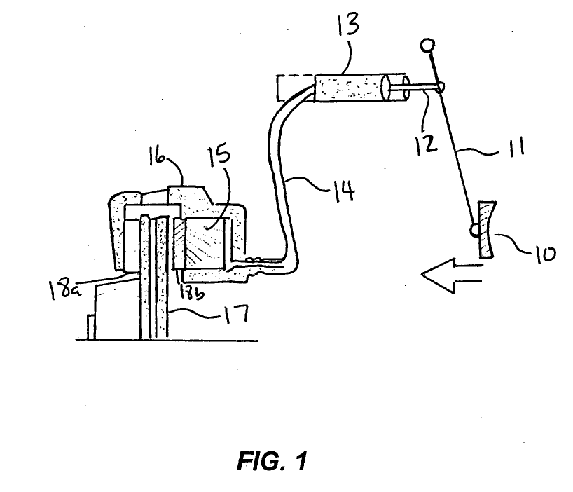

FIG. 1 illustrates the basic configuration for activating the brake system in a motor vehicle. This system comprises a pedal 10 that the driver uses to activate the brakes. Rods 11 and 12 attach a pedal 10 to a moveable piston 12. The piston moves linearly in cylinder 13. The cylinder 13 is commonly referred to as the master cylinder. Also contained in cylinder 13 is brake fluid, which serves to multiply the force the driver applies to the brake pedal. A brake line 14 is physically and fluidly attached to the cylinder 13. The brake line 14 also attaches to a brake piston 15 that is contained within the brake housing 16. The brake housing encompasses the wheel rotor 17, which is attached to the vehicle wheel. Brake pads 18a and 18b contact the rotor to slow the rotation of the rotor and wheel.

In operation, the driver would press the brake pedal to stop the vehicle. This movement of the brake pedal forces rod 11 in the direction of the applied force. As rod 11 moves in the direction of the force rod 12 causes the piston to move in that same direction. When the piston moves it pushes brake fluid in the cylinder into the brake line 14. The pressurized fluid pushes the brake piston 15 and brake pad causing brake pad 18b to contact the wheel rotor 17, thereby slowing down the wheel rotation and the vehicle.

During the braking process, lights on the rear of the motor vehicle illuminate to indicate to other drivers that the vehicle is slowing down. In this illumination process, a switch is positioned at a location between the pedal 10 and the dashboard. The switch can be directly behind the brake pedal 10. When the driver applies pressure to the brake pedal, the switch closes causing electrical current to flow to and illuminate the brake lights. When the driver releases the brake pedal, the switch opens and stops the current. At that point, the lights go off.

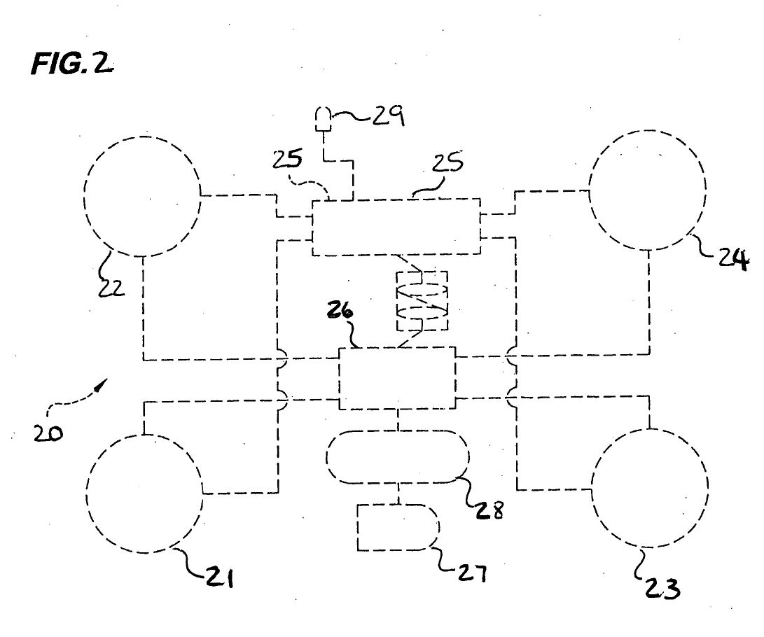

FIG. 2 shows a schematic of the anti-lock braking interior alerting system 20. This system informs the driver of the activation of the ABS. As previously mentioned, the ABS has four main components: speed sensors, pumps, valves and controller. The speed sensors 21, 22, 23, and 24 are located at each wheel and detect when a wheel is about to lock up. The speed sensors transmit information to the electronic brake control module (controller) 25. In addition, an ABS solenoid 26 also receives signals from the speed sensors.

During ABS operations, when there is a sudden application of the brake pedal 27, the speed sensors detect the sudden deceleration of the wheels. These sensors send a signal to the solenoid. The solenoid, comprising the valve and pump, manipulate the master cylinder 28 such that a series of short pumps is produced that prevents the locking of the wheels. The electronic brake module also receives the signal from the speed sensors and activates an ABS alert signal. This signal is displayed as a light 29 in the vehicle dashboard.

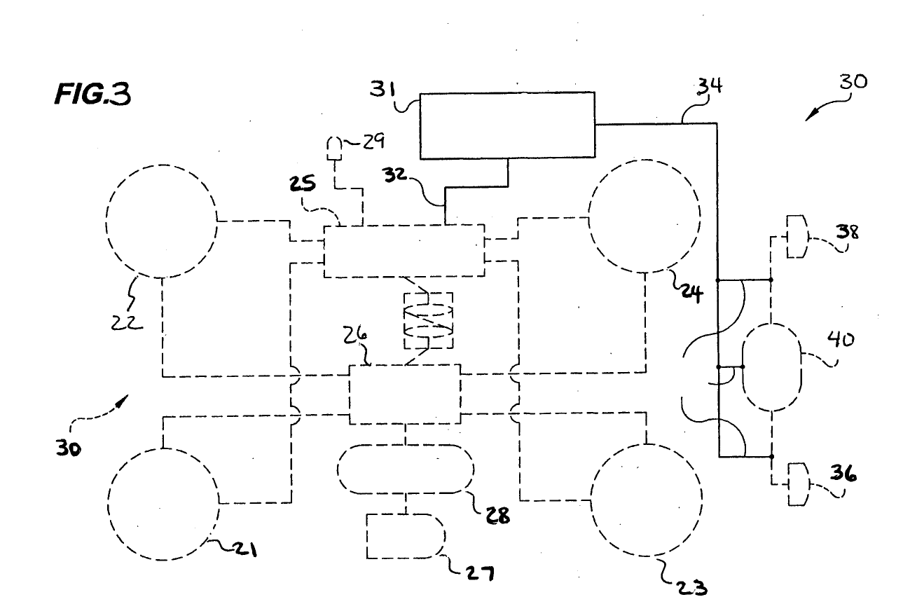

FIG. 3 is a schematic of a braking lighting system for an anti-lock brake system in accordance with the present invention. As mentioned, in addition to displaying the ABS signal to the driver through a dashboard display, this system 30 displays the ABS signal to other drivers through the current brake lights on the vehicle. In addition to the components illustrated in FIG. 2, the present invention further comprises an exterior ABS alerting system module (EABSAS) 31. This EABSAS connects to the electronic brake control module 25 that supplies the signal to the dashboard display. An electronic means 32 facilitates this connection. The EABSAS also connects to the exterior brake light system of the vehicle through an electrical connection 34. A conventional brake light system can comprise a left rear brake light assembly 36, a right rear brake light assembly 38, and a third brake light 40.

The present invention operates in the same manner as described in FIG. 2 with the additional step of sending the alerting signal to the exterior brake light system as well as the display light 28 inside the device. The signal may be sent via a separate circuit from the EBCM to the brake lights or it may be used in tandem with the Drivers' Interior ABS alerting signal. In other words, the signal to the Driver's interior ABS Alerting

The alerting signal may be extended to the EABSAS override module and tied into the rear brake lamping circuitry. To accomplish the transmission of the signal to the conventional external brake light system, the present invention can employ an override function. During an emergency braking activity, this function would override the normal brake signal that is sent to the external brake light system and display to ABS braking signal from the EABSAS module 30. The Exterior ABS Alerting System/Strobe Module (EABSAS) contains an override module. This module can be programmed with an electronic bias to the signal being sent from the Electronic Brake Control Module (EBCM) over the signal being sent from the brake pedal that activates normal brake light operation. This bias results in the termination of normal brake lamping operation and activation of one or more EABSAS mechanisms. The only time the EABSAS module will be activated is when the signal from the EBCM is sending a signal to the brake system and the driver's interior alerting signal. The signal may be sent to the third braking light and/or the other braking light modules at the rear of the vehicle.

The EABSAS module may also be used in conjunction with the existing brake light operation. In this capacity, normal brake lamp operation will remain operational and the EABSAS module will flash/strobe the additional EABSAS lights in conjunction or tandem with the normal braking light(s) operation.

The implementation of the circuitry from the EBCM can have various embodiments. In one embodiment, the third brake light may have one or more additional high or low intensity light bulbs added to the third brake module where the normal brake light(s) may be temporarily disabled during EABSAS operation while one or more EABSAS bulbs will be flashing and/or strobing during EABSAS module operation. The normal brake light may also be left in operation while the additional EABSAS lights flash/strobe to indicate operation of the EABSAS system.

In a second embodiment, the two brake light modules at the rear of the vehicle may have one or more high or low intensity light bulbs added to their structure to operate independently, in tandem, or sequentially with the third brake light mechanism described above. Their normal brake light may be temporarily disabled when the EABSAS module is activated or they may remain operational in addition to the signals given by the flash/strobe lights in the EABSAS.

In a third embodiment, the two brake light modules at the rear of the vehicle may have their existing lights receive the EABSAS signal and flash as they do during ‘emergency light’ operation. The third brake light may also have a similar ‘emergency flasher’ operation to be activated when the signal is received from the EABSAS module. The rear brake lights may operate in conjunction or sequentially when the EABSAS is activated.

The EABSAS module may also activate the vehicle's existing ‘emergency light’ operation in conjunction, sequentially or separate from the strobing light mechanism previously discussed. Use of the ‘emergency light’ mechanism will give additional emergency light information to those in front of the vehicle ‘in extremis’.

The exterior ABS activation indicator of the present invention provides a quick and efficient means to convey emergency information to other cars. As mentioned, this invention utilizes the existing brake light signal to convey information to other motorists about the braking duress of the driver. A concept of the invention is that fast flashing lights are instantly recognizable to all drivers and requires no monitoring for driver to decide if actions are needed. The invention is also invaluable to nighttime drivers who are driving without the benefit of physical proximity information that daylight affords them to make a braking decision. A normal ABS that is activated at night looks no different to oncoming traffic than does normal braking operations from a distance. The present invention shaves valuable seconds off brake response time and potentially save lives and injuries, day and night.

The present invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. An exterior activation indication system for an anti-lock braking system of a motor vehicle comprising:
an electronic brake control module for sending a signal indicating the activation of the anti-locking braking system of a motor vehicle;
wheel speed sensors to detect a sudden deceleration of wheel speed, said wheel speed sensors being connected to said electronic brake control module;
an exterior anti-lock braking system module for causing a signal to be displayed through an exterior brake light that will indicate to other motorist an emergency braking condition of the motor vehicle containing said exterior anti-lock braking system module;
an anti-lock braking system solenoid for controlling braking activity of a motor vehicle when the anti-lock braking system of the motor vehicle is activated;
a brake light assembly that illuminates during the activation of an anti-lock braking system, said brake light assembly illuminating in as directed by said exterior anti-lock braking system module and in response to anti-lock braking activity of the vehicle; and
an override mechanism connected to said exterior anti-lock braking system module to override a conventional brake light signal with a signal from the exterior anti-lock braking system module when the anti-lock braking system is active.

2. The exterior activation indication system for an anti-lock braking system as described in claim 1 wherein said brake light assembly is located at the rear of a motor vehicle and further comprises a left rear brake light assembly and a right rear brake light assembly.

3. The exterior activation indication system for an anti-lock braking system as described in claim 2 wherein said brake light assembly further comprising a third brake light assembly located at the rear of the motor vehicle and between said left and right brake light assemblies.

4. The exterior activation indication system for an anti-lock braking system as described in claim 1 wherein said brake light assembly is located at the rear of a motor vehicle and further comprises a brake light assembly positioned in the rear center of a motor vehicle.

5. The exterior activation indication system for an anti-lock braking system as described in claim 1 wherein the lights of said brake light assembly illuminate in a strobing manner to indicate the activation of the anti-lock breaking system of a motor vehicle.

6. The exterior activation indication system for an anti-lock braking system as described in claim 1 wherein the lights of said brake light assembly illuminate in a rapid flashing manner to indicate the activation of the anti-lock breaking system of a motor vehicle.

7. The exterior activation indication system for an anti-lock braking system as described in claim 1 wherein said electronic brake control module further comprises a pump and a control valve.

8. The exterior activation indication system for an anti-lock braking system as described in claim 1 wherein said wheel speed sensors comprise a wheel speed sensor for each wheel of a motor vehicle.

9. The exterior activation indication system for an anti-lock braking system as described in claim 1 wherein said wheel speed sensors comprise a common wheel speed sensor for rear wheels of a motor vehicle
